(19) United States
(12) Patent Application Publication
(10) Pub. No.: US 2020/0059447 A1
(43) Pub. Date: Feb. 20, 2020

(54) Method and System for E-mail Recipient Verification

(71) Applicant: Reuben Bahar, West Hills, CA (US)

(72) Inventor: Reuben Bahar, West Hills, CA (US)

(21) Appl. No.: 16/189,959

(22) Filed: Nov. 13, 2018

Related U.S. Application Data
(60) Provisional application No. 62/718,387, filed on Aug. 14, 2018.

(51) Int. Cl. H04L 12/58; G06F 17/27

(52) U.S. Cl. CPC H04L 51/30; G06F 17/27; H04L 51/22

(57) ABSTRACT

A method and system for verifying that an electronic communication is sent to the intended recipient prior to the communication actually being sent comprises: detecting a recipient name in a body of the communication and determining whether the detected recipient name is a match or potential mismatch with a destination indication or name associated with the destination indication.

### CROSS-REFERENCE TO RELATED APPLICATIONS

This application claims benefit to Provisional Application No. 62/718,387 filed Aug. 14, 2018, which is incorporated herein by reference.

### FIELD OF THE DISCLOSURE

This disclosure is generally directed to improved electronic communication systems including email and text messaging systems.

### BACKGROUND OF THE DISCLOSURE

Electronic communications (e.g. email, text messages) are often sent in haste. Such systems typically include features facilitating speed and encouraging haste, such as allowing a message to be sent by the click of a virtual button, and enabling the sender to type only one or a few first characters of the recipient name and then select the correct recipient from one or more recipients displayed by the system. However, sending a communication with speed and/or in haste may sometimes result in error, such as sending the communication to an unintended recipient. As such, there is a need for improvements in such systems for preventing sending communications to unintended recipients.

### BRIEF SUMMARY OF THE DISCLOSURE

Various inventive features are described below that can each be used independently of one another or in combination with other features.

In accordance with various embodiments, disclosed is a method and system for verifying that an electronic communication is sent to the intended recipient prior to the e-mail actually being sent by the sender (i.e. composer of the e-mail). In some embodiments, the electronic communication may be an email. In some embodiments, the electronic communication may be a phone text message.

In accordance with various embodiments, disclosed is an email security method comprising: detecting a recipient name in a body of an email; detecting a recipient name associated with a recipient email address; wherein upon detecting of a mismatch between said recipient name in said body of the email and said recipient name associated with said recipient email address, prompting a user to confirm the accuracy of the recipient e-mail prior to sending the email.

In accordance with various embodiments, disclosed is an electronic communication method comprising: detecting and/or retrieving at least one recipient name from a body of an electronic communication; comparing and/or analyzing the at least one recipient name with a destination indication of the electronic communication and/or a destination name associated with the destination indication; and determining whether there is a match, a mismatch, and/or a potential mismatch between: a) said at least one recipient name, and b) said destination indication and/or said destination name, wherein the electronic communication method is automated and reduces the risk of transmitting the electronic communication to an unintended recipient.

In some embodiments, the method reduces the risk of transmitting the electronic communication due to human error. In some embodiments, the method further comprises detecting and/or retrieving at least one destination name associated with the destination indication wherein the at least one destination name comprises a text string associated with a name. In further embodiments, an alert is issued if a mismatch and/or potential mismatch is determined. In yet further embodiments, if a mismatch and/or potential mismatch is determined, the method further comprises issuing an alert as to a potential error, and/or prompting a composer of the electronic communication to confirm the destination indication prior to transmission of said electronic communication.

In some embodiments, the method further comprises learning and/or establishing an association between the at least one recipient name and the recipient destination indication. In further embodiments, the method further comprises comparing and/or analyzing the at least one recipient name with the at least one destination indication by using an established association relating to the destination indication. In yet further embodiments, detecting and/or retrieving at least one recipient name from the body of the communication comprises searching for and/or detecting at least one of: an initial word string of the body of the communication; a recognized common name; a name from a preprogrammed list of names an unrecognizable and/or or a non-dictionary word; a word string comprising a capitalized first letter; a word string following a common salutation and/or title; a word string in the first line of the body message; a name associated with the destination indication; or a combination thereof.

In some embodiments, the destination name is at least part of a text string in the destination indication, and/or at least part of a text string in an identification name associated with the destination indication. In further embodiments, the electronic communication comprises an email, and the recipient destination indication is an email address. In yet further embodiments, the electronic communication is a text message, and the destination indication is a phone number.

According to various embodiments, disclosed is an electronic communication system comprising: software configured to perform an automated determination of whether a recipient name entered into a body of an electronic communication is a match, a mismatch and/or a potential mismatch, with a) a destination indication of the electronic communication and/or b) a destination name associated with the destination indication, wherein the automated determination reduces the risk of transmitting the electronic communication to an unintended recipient. In some embodiments, the software is configured to detect and/or retrieve said recipient name from said electronic communication. In further embodiments, the automated determination comprises using a pre-established association between the entered destination indication and a recipient name previously associated with the entered destination indication, to determine whether the previously associated recipient name matches said recipient name entered in the body of the electronic communication. In yet further embodiments, the pre-established association is based on a repeated occurrence of a specific recipient name being used with a specific destination indication, a confirmation that a destination indication and a recipient name are accurately associated, and/or a manually established association.

In some embodiments, the at least one recipient name comprises at least one text string potentially associated with a name in the body of the communication, and/or wherein the at least one destination name is at least part of a text string in the destination indication and/or at least part of a text string in an identification name associated with the destination indication. In further embodiments, if a mismatch and/or potential mismatch is determined, the method further comprises issuing an alert as to a potential error and/or prompting a composer of the electronic communication to confirm the destination indication prior to transmission of said electronic communication. In yet further embodiments, the electronic communication comprises an email, and the destination indication is an email address. In yet further embodiments, the electronic communication is a text message, and the destination indication is a phone number.

According to various embodiments, disclosed is an email method to reduce a risk of transmitting an email to an unintended recipient, the email method comprising: detecting and/or retrieving a recipient name from a body of an e-mail message; detecting and/or retrieving an e-mail address from the recipient field of the e-mail message; comparing and/or analyzing the recipient name with the email address and/or a name associated with the email address; determining whether there is a match, a mismatch, and/or a potential mismatch between: a) the recipient name, and b) the email address and/or the name associated with the email address; and issuing an alert, if a mismatch and/or potential mismatch is determined, wherein the method is automated and implemented via software resident on at least one computer device. In some embodiments, said determining whether there is a match, a mismatch, and/or a potential mismatch comprises at least one of: using a pre-established association between the email address and a recipient name previously associated with the email address, or determining whether a text string in the detected recipient name matches a text string in the email address and/or the name associated with the email address.

In accordance with various embodiments, disclosed is an electronic communication method comprising: detecting, using software resident on a computer device, at least one recipient name from a body of an electronic communication; comparing, using software resident on a computer device, the at least one recipient name with a destination indication of the electronic communication and/or a destination name associated with the destination indication; and determining, using software resident on a computer device, whether there is a match, a mismatch, and/or a potential mismatch between: a) said at least one recipient name, and b) said destination indication and/or said destination name.

In some embodiments, the system and method functions by establishing an association between the intended recipient's name that is typed in the body of the e-mail and the designated recipient e-mail address that is present in the e-mail platform “to:” field.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGs and examples are not meant to limit the scope of the present subject matter to a single embodiment, but other embodiments are possible by way of interchange of some or all of the described or illustrated elements and, further, wherein:

The drawings described herein are for illustration purposes only and are not intended to limit the scope of the present disclosure in any way. The present disclosure will become more fully understood from the detailed description and the accompanying drawings wherein:

FIG. 1 shows an electronic communication method, in accordance with various embodiments of the present disclosure;

FIG. 2 shows an electronic communication display for an email communication, in accordance with various embodiments;

FIG. 3 shows an electronic communication display for a phone text message communication, in accordance with various embodiments;

FIG. 4 is shows a step for detecting and/or retrieving a name from a body of a communication, according to various embodiments;

FIG. 5 illustrates an email system display in accordance with various embodiments;

FIG. 6 illustrates an email system display with a “warning pop-up box” in accordance with various embodiments;

FIG. 7 illustrates an email system display comprising a recipient association data input menu, in accordance with various embodiments;

FIG. 8 illustrates an email system display in accordance with various embodiments; and

FIG. 9 an email system display in accordance with various embodiments.

While the disclosure is subject to various modifications and alternative forms, specific embodiments thereof are shown by way of example in the drawings and the accompanying detailed description. It should be understood, however, that the drawings and detailed description are not intended to limit the disclosure to the particular embodiments. This disclosure is instead intended to cover all modifications, equivalents, and alternatives falling within the scope of the present disclosure as defined by the appended claims.

### DETAILED DESCRIPTION OF ILLUSTRATIVE EMBODIMENTS

The detailed description set forth below in connection with the appended drawings may be intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration. Although the device(s) here disclosed have been described in detail herein with reference to the illustrative embodiments, it should be understood that the description may be by way of example only and may be not to be construed in a limiting sense. It may be to be further understood, therefore, that numerous changes in the details of the embodiments of the disclosure will be apparent to, and may be made by, persons of ordinary skill in the art having reference to this description. It may be contemplated that all such changes and additional embodiments are within the spirit and true scope of this disclosure as claimed below.

Unless specifically stated otherwise, references to “a”, “an”, and/or “the” may include one or more than one and that reference to an item in the singular may also include the item in the plural. It is to be understood that the phrases “one or more” and “at least one” refer, for example, to instances in which one of the subsequently described circumstances occurs, and to instances in which more than one of the subsequently described circumstances occurs.

The term “optional” or “optionally” refer, for example, to instances in which subsequently described circumstances may or may not occur, and include instances in which the circumstance occurs and instances in which the circumstanced do not occur. The term “about” used in connection with a quantity is inclusive of the stated value and has the meaning dictated by the context (for example, it includes at least the degree of error associated with the measurement of the particular quantity). When used in the context of a range, the term “about” should also be considered as disclosing the range defined by the absolute values of the two endpoints. For example, the range “from about 2 to about 4” also discloses the range “from 2 to 4”.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step.

With reference to the accompanying figures, and in accordance with various embodiments, the present disclosure is generally directed to system and method for electronic communication, and more specifically to a system and method for avoiding error when sending electronic communication. In particular the disclosed method is directed to preventing and/or reducing the risk of sending an electronic communication to a wrong or unintended recipient and/or for verifying that the electronic communication is sent to the intended recipient prior to the communication being electronically transmitted by the sender (i.e. composer of the communication). In embodiments, the electronic communication comprises an email message. In some embodiments, the electronic communication may be a phone text message.

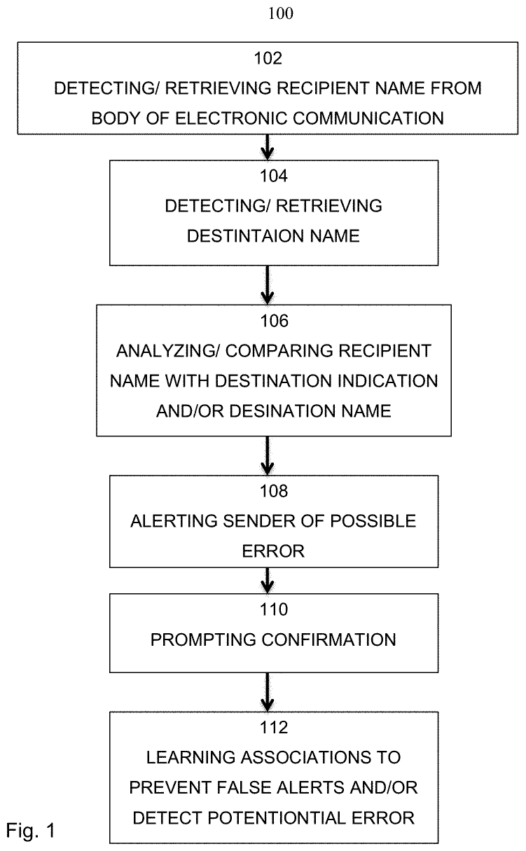

FIG. 1 shows a system and method 100 for avoiding error when sending electronic communication (“an electronic communication method 100”). In embodiments, the electronic communication method 100 is directed to preventing and/or reducing the risk of sending a communication to a wrong or unintended recipient and/or for verifying that the communication is sent to the intended recipient, prior to electronic transmission of the communication. According to various embodiments, the method 100 may comprise detecting and/or retrieving at least one recipient name from a body of the electronic communication (step 102). In embodiments, the at least one recipient name may comprise a text (i.e. text string) associated with or potentially associated with a name. According to various embodiments, method 100 may further comprise detecting and/or retrieving at least one destination name associated with a recipient destination indication (step 104), wherein the at least one destination name comprises a text string associated with a name, which may be the name of a receiver of the electronic communication based on the destination indication. In embodiments, a destination indication may be a recipient e-mail address, a recipient mobile phone number, a recipient account user name, and/or any other designation heading leading to an electronic communication destination and/or user account. In embodiments, method 100 may further comprise a step 106 of analyzing and/or comparing the at least one recipient name (i.e. text string detected in step 102) with the destination indication of the electronic communication and/or the at least one destination name (i.e. text string detected/retrieved in step 104) to determine whether there is a match, a mismatch, and/or a potential mismatch between the compared elements (i.e. between the recipient name and destination indication and/or between the recipient name and destination name). In embodiments, step 106 may comprise analyzing and/or comparing the at least one recipient name with the at least one destination name to determine a potential error, which may be based on a mismatch, or absence of a match, between the detected text strings. In some embodiments, step 106 may comprise analyzing/and or comparing the recipient name with the destination indication based on a previously established association between the destination indication and a recipient name, wherein if the recipient name detected in step 102 does not match the recipient name associated with the destination indication, a mismatch and/or potential mismatch is determined. Thus, the electronic communication method 100 provides an automated secondary/backup check to reduce the risk of sending an electronic communication to an unintended recipient due to factors such as human error and/or other causes.

In embodiments, upon detection of a mismatch and/or a potential mismatch between the at least one recipient name with the at least one destination name, the method 100 may further comprise alerting a sender (i.e. composer of the message) as to a possible error (step 108). In some embodiments, upon detection of a mismatch or a potential mismatch between the names detected in steps 102 and 104, the method 100 may further comprise a step 110 of prompting the sender to indicate/confirm the accuracy of the recipient destination indication and/or recipient name prior to sending the communication and/or indicate the inaccuracy of the recipient destination indication and/or recipient name. In some embodiments, the method may further comprise learning/establishing associations between a recipient name and a destination indication (step 112) to prevent future false alerts (or repeating an alert), to analyze future communications and/or to determine potential error.

In embodiments, the method 100 may be implemented via software/hardware resident on at least one electronic device (i.e. a computer device such as a P.C., laptop, Tablet, smartphone, and the like) configured to execute steps of method 100. This may include various devices in communication with one another, wherein at least one device is configured to execute said steps and/or a plurality of devices collectively configured to execute said steps.

Electronic Communication System

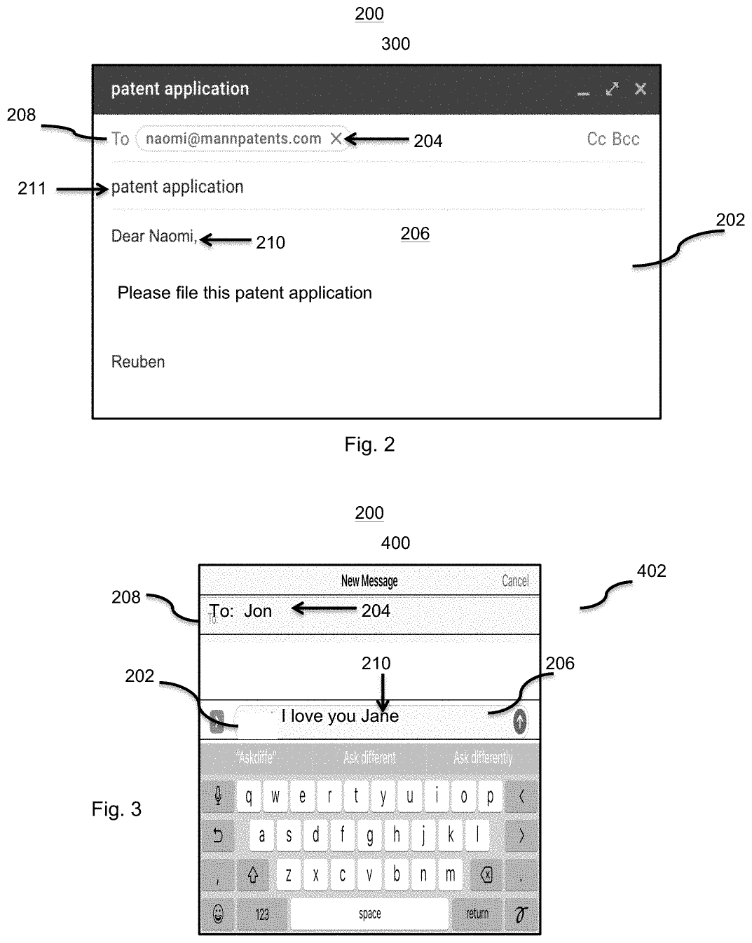

With reference to FIGS. 2 and 3, an electronic communication 200 may typically include a body 202 of the communication, and at least one destination indication 204, which may be inputted by a sender/composer of the communication 200. As is well known, an electronic communication may be managed through a communication managing system (including at least one communication managing program, application, hardware, and/or software, and the like), which may be computer based (including cloud based, web based, and/or cell phone based, and the like).

Typically, a body field 206 is provided for inputting the body 202 of the communication, and at least one destination field 208 is provided for inputting the at least one destination indication 204. In some embodiments, an electronic communication managing system may be configured to allow a user (i.e. sender/composer) to input a few first characters of the destination indication 204, wherein the system may retrieve at least one complete destination indication associated with the first few letters and input the complete destination indication automatically and/or based on an indication by the user (such that the user does not have to type in the complete destination indication), as is well known. Some systems may also be configured to automatically fill in portions of the body 202 of the communications.

In embodiments, the communication 200 may be sent to and from a variety of electronic devices, e.g. computers, tablets, smartphones, iPhones, smart watches, and the like, working alone or in combination, including devices which are paired, according to various embodiments. In embodiments, the communication may be sent from one type of device to the same type of device, to another type of device, and/or to multiple devices.

FIG. 2 provides an example of an electronic communication 200 comprising an email 300. As shown in the figure, the body 202 may comprise a message (which is typically, but not necessarily textual), which may include a name 210 (“recipient name”), according to various embodiments. In embodiments, the recipient name 210 may be detected and/or retrieved from the body 202 of the communication according to step 102. In embodiments, the body 202 is inputted in the body field 206 of the email 300. In some, but less typical cases, the body field 206 may be left blank, wherein the subject line 211 and/or an attachment (not shown) may be used for conveying the message or as the body 202 of the email. In such cases, the subject line 211 and/or attachment would constitute the body 202 wherein the recipient name would be extracted from the subject line and/or attachment according to step 102.

Additionally, the at least one destination indication 204 may comprise an email address (as shown) and/or a name associated with an email address inputted into the destination field 208, from which a destination name associated with the destination indication 204 can be extracted according to step 104. In some embodiments, the disclosed concept contemplates a destination indication for an email communication, comprising a contact phone number and/or name associated with a contact phone number, such that the email message (i.e. message sent via an email managing system) may transmit to a phone text message. In such embodiment, the name extracted according to step 104 may be the name associated with the phone number.

In embodiments, the destination field 208 may appear as a rectangular box over the top of the body field 206 of the email 300, and/or include a heading, such as “To:” (as shown in the figure), “Recipient”, and the like, to indicate that it is the destination field 208, as is well known. Additionally, the destination field 208 may allow for more than one destination indication and/or a combination of different types of destination indications (e.g. a first email address and name associated with a second email address, according to various embodiments). In some embodiments, the destination field may include a “Cc” (Carbon copy) field, a “Bcc” (Blind carbon copy) field, and the like, for inputting one or more destination indications, as is well known.

FIG. 3 provides an example of an electronic communication 200 comprising a text message 400, which is typically sent through a phone device, such as a smartphone (e.g. iPhone®). (In some embodiments, the message may be sent through a device paired to the phone, such as a smartwatch). As shown in the figure, the body 202 may comprise a message (which is typically, but not necessarily textual), which may include a name 210 (“recipient name”), according to various embodiments. In embodiments, the name 210 may be extracted from the body 202 of the text message 400 according to step 102. Additionally, the at least one destination indication 204 may comprise a phone number, a name associated with a phone number (as shown), an email address, and the like, which may be inputted into the destination field 208, and from which a destination name associated with the destination indication 204 may be extracted according to step 104. In embodiments, the destination filed 208 may appear, for example as a rectangular box at the top of a phone screen 402, and/or may include an destination field indication, such as “To:” (see Figure), “Recipient”, and the like. Additionally, the destination field 208 may allow for more than one destination indication and/or a combination of different types of destination indications (e.g. a first phone number and name associated with a second phone number, according to various embodiments).

While examples of email and phone text messages are provided, the present disclosure should not be construed as limited to these types of electronic communications alone, and contemplates application to other types of electronic communications, including a variety of different electronic communication transmission system, managing programs/applications, and devices which are or may become available with emerging technology.

Detecting/Retrieving Recipient Name From Body of Communication

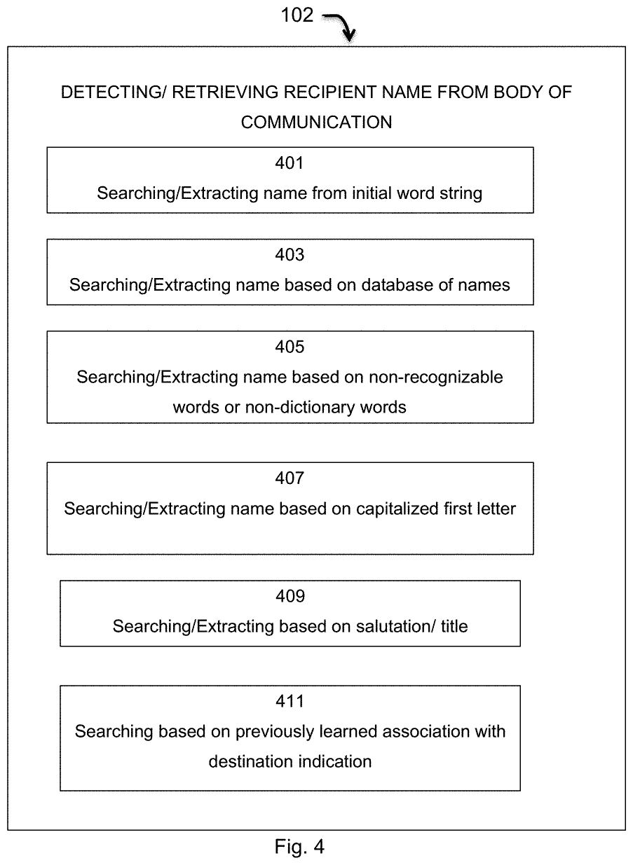

According to various embodiments, the body 202 of the communication 200 may typically include a digitally written message which may comprise a name of the intended recipient (“recipient name”). According to various embodiments, the recipient name may include a first name, a last name, both a first and last name, a shortened form of the name (e.g. Jo instead of Joseph), a nickname, an endearment name, and the like. Various methods for detecting a recipient name (which is an assumed name of the intended recipient, to be analyzed according to step 106) from the body 202 of the communication 200 may be employed, according to step 102 (see FIG. 4). In embodiments, such methods for detecting a name may be based on typical habits and/or conventions employed in composing text based communications.

In embodiments, step 102 may comprise searching for and/or detecting a name from an “initial word string(s)” of the body of the communication and/or from a first line of the body of the message (step 401). In some embodiments, the initial word string(s) may be a first, a second, or a third word data string(s), at the beginning of the body of the communication, and/or on a first line of the communication, wherein each word data string may be preceded and followed by at least one space. For example, an initial word string can be the recipient's first name, e.g. “Mike”. In another example, this can be the recipient's last name with a title in front of it, e.g. “Mr. Jones”. In some examples, this can be the recipient's first and last name, e.g. “Tom Jones”. According to some conventions, the name may be headed by a greeting such as “Hi”, “Hello”, “Dear”, “To”, etc., as in “Hi Mike”; “Dear Mr. Jones”; etc., and the like. This practice is commonly done in order to designate the communication to the intended recipient and acknowledge that the message is for them.

In some embodiments, step 102 may comprise searching for and/or detecting a recognized common name, which may be based on a database of common names, (e.g. Mike, Bob, Joe) and/or a stored list of names (step 403). For example step 403 may comprise extracting/detecting the name from the body 202 by relating and/or matching the word data string of the name to a name on a stored database of names.

In some embodiments, step 102 may comprise searching for and/or detecting a name by determining the word data string of the name as an unrecognizable word or a non-dictionary word (step 405). In some embodiments, this may include the recognition of a data string(s) as a name, regardless of whether it can be recognized as a common name (e.g. Merp, Lief, etc.).

In some embodiments, step 102 may comprise a step 407 of recognizing a word string as a name by searching for and/or detecting a capitalized first letter on the word string.

In some embodiments, step 102 may comprise a step 409 of recognizing a word string as a name by searching for and/or detecting a common salutation and/or title preceding the word string (e.g. “Hi”, “Hello”, “Dear”, “To”, “Attention”, “Attn:”, “Mr.”, “Mrs.”, etc.).

In some embodiments, step 102 may comprise a step 411 searching for and/or detecting an expected name based on the destination indication. In some embodiments, an expected name may be a name based on a previous learned/established association between a given destination indication and recipient name (according to step 112). Thus, in some embodiments, step 411 may comprise searching, in the body of the communication, for a name previous associated with the entered destination indication. For example, say “michael@gmail.com” has been previously established as associated with the name Mike, according to step 112, then step 411 may comprise searching for the name “Mike” in the body of the communication. In some embodiments, an expected name may comprise a recognized common name associated with the destination indication. For example, “michael@gmail.com” may be associated with the name “Michael, which is a known common name, in which case step 411 may comprise searching for the name “Michael” in the body of the communication.

In embodiments, step 102 may comprise at least one, or a combination of more than one of steps 401, 403, 405, 407, 409, and 411. In some embodiments, step 102 may employ alternate steps, after initial steps have failed to detect a name. For example, step 102 may search for a common name in an initial word string, according to steps 401 and 403. Thereafter, if no name has been found, step 102 may further detect a common salutation, and search for a name following the salutation, according to step 409.

Additionally, the steps provided herein for detecting the recipient name from the body of the communication should not be construed as limiting. The present disclosure contemplates other methods for detecting a name from a body of a communication, which are or may become apparent to one skilled in the art, based on current and/or future technologies, conventions, societal habits, etc., which may vary based on different societies, communities, countries, etc.

Detecting and/or Retrieving Destination Name Associated With a Recipient Destination Indication

According to various embodiments, a destination name may be at least part of a text string in the destination indication itself, and/or at least part of a text string in an identification name associated with the destination indication. An identification name associated with the destination indication may be a name under which the destination indication is stored (e.g. a name under which an email address or a phone number is stored), and/or an account identification (id) name of an account associated with the destination indication (e.g. an id of a social media account associated with an email address or phone number).

According to various embodiments, detecting and/or retrieving a destination name from a destination indication may comprise retrieving at least part of the name from the destination indication itself, a name under which the destination indication may be stored, and/or the name of an account associated with the destination indication.

Typically, a destination indication includes, is stored under, and/or can be associated to, at least part of a name of the owner of that destination indication. As such, text associated with the destination indication or the destination name, according to step 104 may often include at least part of a name of an owner/user of the destination indication.

For instance, a conventional email address may typically include a local-part before the @ sign, followed by a domain i.e. local-part@domain. Although there may be a large number of variations as to how a particular user designates his email address, most email addresses will include at least part of the email user's name in at least the local-part and/or domain of the address. For example, an individual with the name Jane Smith may have an email address such as jsmith@gmail.com; or jane@smithco.com; or janesmith@gmail.com; or jane-smith@aol.com, etc. Thus, according to various embodiments, a text string/destination name retrieved according to step 104 for a recipient destination indication comprising an email, may comprise the local-part, the local-part and domain, and/or the domain of the email address.

Additionally, many conventional email systems store an email address under the email user's full name. For example, jsmaith@gmail.com may be stored or associated with the name “Jane Smith”. Thus, according to various embodiments, a text string retrieve according to step 104 for a recipient destination indication comprising an email, may comprise at least part of the name under which the email address is stored or associated to. In some embodiments, an email address may be associated with a second electronic communication account, for example a social media and/or communication account (e.g. Facebook®, Instagram®, Whatsapp®, etc.), wherein the account ID may contain at least part of the name of the account owner.

According to various embodiments, in cases where a communication is being sent to multiple recipients, i.e. where multiple email addresses are indicated in at least one recipient destination field (e.g. “To” “Cc” “Bcc”, and the like), a text string associated with each email address may be analyzed separately.

As another illustration, a phone number may be associated with at least part of a name of the phone number owner. For instance, the phone number (of the recipient of the communication) may be stored/saved (e.g. by the sender of the communication in a phone contact list of the sender) under a contact name, which may often include at least part of the phone number owner's name. (Conventional cell phones as well as smart phones such as iPhones®, Galaxy®, Android® etc., typically include a feature which allows the phone owner to store the phone numbers and associated names of various individuals in a contact list). In some embodiments, the phone number may be associated with a second electronic communication account, for example an email account, or other social media and/or communication account (e.g. Facebook®, Instagram®, Whatsapp®, etc.), wherein the account ID may contain at least part of the name of the account owner. Thus, according to various embodiments, the text string retrieved according to step 104 for a recipient destination indication comprising a phone number, may comprise a saved contact name, which may be from the sender's saved contact's) associated with the phone number, and/or text string from an account ID of another electronic communication account associated with the phone number. According to various embodiments, in cases where a communication is being sent to multiple phone recipients, (e.g. to a “group”), a text string associated with each phone number may be analyzed separately.

Analyzing/Comparing Text Strings Retrieved in Steps 102 and 104 to Determine Potential Error (Step 106)

According to various embodiments, the method 100 may analyze the text strings detected according to steps 102 and 104 to determine if there may be a match, or a mismatch (or potential mismatch) between the names, and thus a potential error on the part of the sender. As such, step 106 may employ various methods in determining a match, wherein the absence of a match may be deemed a mismatch and/or a potential mismatch, according to various embodiments.

For example, in embodiments, a match/mismatch may be determined based on whether at least part of the text string retrieved according to step 102 matches at least part of the text string retrieved in step 104. In some embodiments, step 106 may comprise determining a match/mismatch based on whether the entire text string associated with a name retrieved according to step 102 appears in any part of the text string associated with the text retrieved according to step 104 or visa versa. For example, text string such as “dan” and “dansmith” may be determined a match; or “John” and “Jonathan” may be determined a match, according to various embodiments.

In some embodiments, determining a match may be based on a match between a string of at least 3 characters appearing in both texts. For example, “Jan8” and “Janetsmith”. In some embodiments, determining a match may be based on recognizing common names and their shortened versions or nicknames, regardless of a common string of characters (i.e. Charles and Chuck; Joseph and Jo; William and Bill; etc.). Other examples may be apparent to one skilled in the art.

In various embodiments, more than one method may be employed to determine a match, and the failure to determine a match may be deemed a mismatch. Additionally, in some embodiments, more than one text string may be retrieved according to either steps 102 and/or 104, and analyzed according to step 106.

In some embodiments, a match may be determined based on a previously learned/established association, according to step 112, as detailed below.

### Alerting of Possible Error 108

According to various embodiments, upon detection of a mismatch (according to step 106), the sender may be alerted as to a possible error, according to step 108. In embodiments, alerting the sender may comprise issuing a warning alert and/or warning message via an indication comprising text, graphic, sound, haptics, and the like, or combinations thereof. In some embodiments, the type of warning indication may be set and/or customized by the user.

In embodiments, the warning alert may be initiated upon an attempt to send the message. (e.g. when the sender clicks on a “Send” command/indication of an email). However, according to various embodiments, a warning message may be presented to the sender at any time at which the message is being created and a recipient destination indication has been entered. (For example, an email may be addressed to Jim@abc.com, while the sender may start typing “Dear Jo”; in such a case, a warning alert may issue while the sender is still in the process of typing the body of the communication, according to various embodiments.

Prompting Confirmation 110

According to various embodiments, upon detection of a potential error and/or mismatch, and/or upon the issuance of a warning alert according to step 108, the sender may be prompted to confirm the accuracy or inaccuracy of the communication fields and/or take various actions indicating such confirmation. In embodiments, the communication may be prevented from being transmitted until the sender provides confirmation and/or overrides the warning alert.

Various methods of overriding the warning alert by the sender may be utilized. For example, overriding the warning alert may comprise confirming accuracy, indicating the alert should be ignored, indicating the communication should be sent anyways, etc., according to various embodiments. This may entail, for example, mouse clicking via mouse, touch activation, etc.

Alternatively, the sender may indicate that the communication should not be sent in response to the warning alert. This may entail clicking a “Cancel” button, or the like. In embodiments, upon indicating that the communication should not be sent, the sender may be allowed and/or be prompted to continue editing the communication. According to some embodiments, method 100 may provide an automated suggestion as to the correct entry (e.g. such as in a pop-up box), or allow the sender to click (e.g. right click), hover over, etc., on an entry for an automated suggestion, and/or manually enter the correction, according to various embodiments.

Learning/Establishing Associations 112

In embodiments, method 100 may further learn and/or establish an association between at least one destination indication and at least one recipient name, according to step 112.

According to various embodiments, learned/established associations may be used to prevent future false alerts and/or to detect potential error. Thus, associations which have been established may be utilized according to step 106 to determine that a recipient name retrieved according to step 102 is a match, mismatch, and/or a potential mismatch, based on associations previously established between the recipient name and destination indication.

An example scenario wherein learned associations may be used to prevent false alerts may be as follows: say the sender composes an email to wsmith@abc.com, with a salutation of “Dear Bill.” Thus, method 100 may issue a warning alert as to a possible error, as the name text “Bill” would be detected as a mismatch if compared to “wsmith” or “abc”. If, however, the sender elected to override the warning alert, (e.g. by clicking on a “do not ask again” pop-up message, or the like) method 100/step 112 may learn to associate the destination indication “wsmith@abc” with the recipient name “Bill” and not issue future alerts. Using the same example, wherein a learned association exists between the destination indication “wsmith@abc” and the recipient name “Bill”, if the sender composes an email using the destination “wsmith@abc” but types a name different than “Bill” in the body, a potential error may be detected; or, if the sender types the name “Bill” in the body, the system may detect a match, according to various embodiments.

In some embodiments, step 112 of learning/establishing associations may be based on repeated and/or a predetermined number of occurrences of a specific name text (i.e. recipient name) being used with a specific destination indication. For example, the association/link can be established after 1 or more occurrences of a specific name text/recipient name being used with the specific destination indication. For example, the association may be established after 2 occurrences, 3 occurrences, 4 occurrences, and so forth.

In some embodiments, step 112 of learning/establishing associations may comprise establishing an association based on a confirmation by the sender that the destination indication and recipient name are accurately associated. This may be, for example, an override by the sender in response to an alert and/or prompt for confirmation upon detection of a possible mismatch. In some embodiments, a confirmation by the sender may be requested the first time a particular destination indication and/or recipient name is used, regardless of whether or not a potential mismatch is detected in order to establish the association for any future use.

In some embodiments, step 112 of learning associations may comprise manually establishing an association by the sender. That is, the communication system may incorporate a feature which allows the sender to establish an association of at least one destination indication with at least one recipient name.

In some embodiments, a specific destination indication may be associated with multiple recipient names, based on multiple communication confirmations of a variety of names, and/or irrespective of the alphanumeric content and/or description of the recipient name(s). For example, an email to Bill.Jones@abc.com may use in the body of the communication any of the following, for example: “Bill”, “Mr. Jones”; “Will”; “Buddy”; “Tom”; “Linda”; “Susan”; etc., wherein with each of these uses, the sender may confirm accuracy of the name, and the method 100 may thus establish associations with each of the recipient names to a single destination indication.

### Example of an Email System and Method for Avoiding Error When Sending Email

In embodiments, the system and method 100 may comprise an email method for verifying that an e-mail is sent to the intended recipient prior to the e-mail actually being sent by the sender (i.e. composer of the e-mail). In various embodiments, the system and method may establish an association between the intended recipient's name that is typed in the body of the e-mail and the designated recipient e-mail address (destination indication) that is present in the e-mail platform “to:” field. Typically, the intended recipient's name may be typed in the first or second word data string(s) (or “initial word string(s)” or “salutation”) at the beginning of the body of the e-mail address. This practice may be done in order to designate the e-mail to the intended recipient and acknowledge that the message is for them. For example, when creating an e-mail message, the sender typically addresses the e-mail message to the recipient by typing their name first, followed by the intended message that they wish to convey. In one embodiment, this can be the recipient's first name such as “Mike”. In an alternate embodiment this can be the recipient's last name with a prefix behind it, such as “Mr. Jones”. In some examples, this can be the recipient's first and last name, such as “Tom Jones”. In each of these cases, repeated e-mail messages by the same sender to the same recipient's e-mail address should typically begin with the same or similar recipient name in the initial word string(s)/salutation portion of the body of the message. In embodiments, such repeated occurrence may establish an association between a recipient's name and their e-mail address. In embodiments, the method 100 may implement software (hereinafter “Learned Association” or “LA” software) that can recognize and learn repeated pattern behavior by searching for repeated matches between a particular e-mail address and a recipient's name in the initial word string(s)/salutation of an e-mail message during the time that it is being composed. In some embodiments, the implemented software may recognize names by recognizing them as common names (e.g. Mike, Bob, Joe); in some embodiments, said software may recognize names by recognizing them as non-dictionary words, regardless of whether they are common names (e.g. Merp, Lief, etc.); in some embodiments, said software may recognize names by virtue of their capitalized first letter, or a combination of the above factors. This will act as a verification tool that enables the sender/creator of an e-mail message to avoid mistakenly sending the e-mail to an unintended recipient e-mail address. When it is detected that there is a mismatch between a designated recipient e-mail address (in the “to:” field) and the recipient name typed in the initial word string(s) a warning message/alert (such as a pop-up window/box) will preferably be displayed to the composer of the e-mail. The warning alert will serve to alert the e-mail composer of the mismatch and/or request that they confirm that the e-mail is correctly addressed to the intended recipient. In embodiments, the warning alert will preferably be initiated at the time that the sender clicks on the “Send” command when intending to send their e-mail message to the selected recipient e-mail address. Of course, this need not be the case and the warning message can likewise be presented to the sender/composer of the e-mail at any time at which the e-mail message is being created and a recipient e-mail address has been designated. In embodiments, the e-mail will not be sent to the designated recipient e-mail address until the composer/sender of the e-mail initiates some action in response to the warning alert. Such action may, for example, entail clicking a “Send” button, which will function to send the e-mail to the designated recipient e-mail address, or alternatively, a “Cancel” button which will return the composer to the e-mail and allow them to continue editing the e-mail, according to various embodiments.

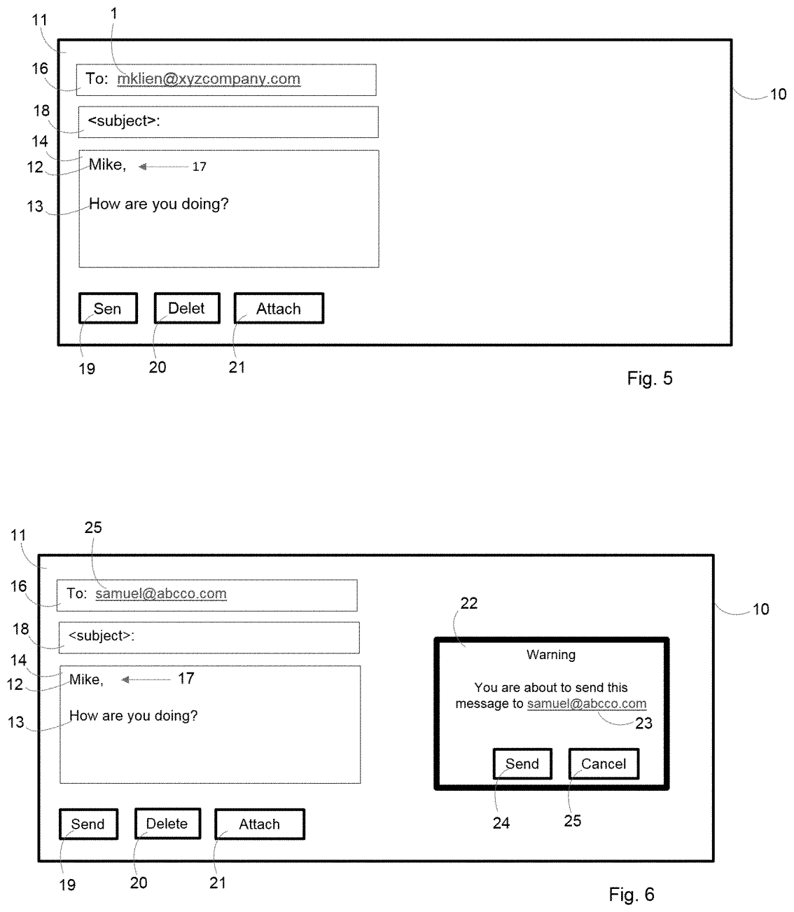

As shown in FIG. 5, an e-mail platform software 10 allows an e-mail composer to create an e-mail message 11 where the recipient's name 12 and message portion 13 are typically contained in the body 14 of the e-mail and the designated recipient e-mail address 15 (destination indication/where the email will be sent) is typically contained in the “To:” 16 section of the e-mail message 11. It is noteworthy that in this example, the initial word string(s) 17 in the body 14 of the e-mail message 11 only contains the recipient name “Mike” 12. In addition, e-mail platform software 10 may typically contain (amongst other features) a “Subject” section 18 (which allows a composer to designate the subject of the e-mail), a “Send” button 19 (which allows the composer to send the e-mail), a “Delete” button 20 (which allows the composer to delete their e-mail draft, and an “Attach” button 21 which allows a composer to include an e-mail attachment to their e-mail.

In embodiments disclosed herein, associating a designated recipient e-mail address 15 with a recipient name 12 (“Mike” as shown in FIG. 1) will make it possible to verify that the e-mail created 11 will be sent to the intended recipient prior to it being sent. According to various embodiments, when an association between a recipient name and a particular e-mail address is established, the LA software will anticipate that future e-mails to the same recipient e-mail address will likewise contain the same recipient name in the initial word string(s) of the e-mail body. In a case where the recipient name is the same as previously used with a particular recipient e-mail address, no warning alert will be issued when the sender attempts to send that particular e-mail, according to various embodiments. If, however, the recipient name that is contained in the initial word string(s) of the body of an e-mail does not match the recipient name that was previously associated with the particular recipient e-mail address, a warning message will preferably be triggered upon an attempt to send the e-mail message.

It is notable that associating a recipient name (contained in the initial word string(s)) to a particular recipient e-mail address can be done by both learned association (LA) as well as manual association (MA). Learned association (LA) entails a process where software preferably installed on the e-mail platform host computer (such as the e-mail service provider's computer server, for example Microsoft Outlook's® server, Google's Gmail® server, or a 3^{rd} party hosting server etc.) is capable of searching for and recognizing a recipient name in the initial word string(s) contained in the body of an e-mail. Upon recognition of a recipient name in the initial word string(s), the software would (automatically or subsequent to a manual confirmation from the composer) link or associate that name to the recipient e-mail address after such address has been designated by the sender/composer as the e-mail account to which their e-mail message will be sent. For example, let's assume that the recipient e-mail address, “mklien@xyzcompany.com” is be used by a user named “Mike”. Here, e-mails sent to this e-mail address from a particular e-mail composer are likely to start off with “Mike” in the initial word string(s) of the body of the e-mail in order to designate the e-mail message to “Mike”. Once the LA software locates/detects the name “Mike” (in this example) in the initial word string(s) and a recipient e-mail address is designated by the composer of the e-mail, the LA software will form an association/link between the name “Mike” and the designated recipient e-mail address mklien@xyzcompany.com. This association can be formed from the first instance where the recipient name (e.g. “Mike”) and designated recipient e-mail address (e.g. mklien@xyzcompany.com) are mutually present, or after repeated occurrences where the same recipient name (e.g. “Mike”) and same designated e-mail address (e.g. mklien@xyzcompany.com) have been detected in distinct and separate e-mail compositions. In the case where the association is established after repeated occurrences where the same recipient name and same designated e-mail address appear in multiple distinct e-mail compositions, the number of repeated occurrences that will trigger the association may be any predetermined and/or fixed number. For example, the association/link can be established after 2 occurrences, 3 occurrences, 4 occurrences, and so forth. In embodiments, a user may be able to indicate an established association (e.g. by clicking on a “do not ask again” pop-up message, or the like).

In another embodiment, wherein a portion of the designated recipient e-mail has the same string of alphanumeric characters as in the recipient name (in the initial word string(s)), the LA software can establish an association between the two. For example, assuming that the designated recipient e-mail was, jack@skyabc.com and that the recipient name in the initial word string(s) was “Jack”, “Mr. Jack”, or “Attn. Jack”, etc. Since the word “Jack” is contained in both the designated recipient e-mail and recipient name, the LA software may automatically create an association between the two. In other embodiments, the LA software may ask the user to confirm the association prior to creating it.

While an association between a recipient name and designated recipient e-mail address can be established automatically by the LA software, it can, in a different embodiment, be established after the composer confirms that they wish to establish such association. Here, the LA software would ask the creator of the e-mail if they would like to form the association prior to forming it. This would allow for an additional level of validation that the association is correct.

After an association is created by the LA software, the software may automatically trigger a warning alert to the sender/composer of the e-mail when the sender/composes creates an e-mail and designates that e-mail to be sent to a recipient e-mail address that is associated with a recipient name that is different than that which was previously associated with the particular recipient e-mail address. Going back to the example presented, a warning alert would be triggered if the email address mklien@xyzcompany.com was associated with the recipient name “Mike”, but a recipient name that was different from “Mike” was typed in the initial word sting(s) of the body of the e-mail. Of course, it is contemplated that in some scenarios, a recipient e-mail address (e.g. mklien@xyzcompany.com) may also be utilized with more than one recipient or recipient names. For example, if both Mike and John are using the same e-mail address such as mklien@xyzcompany.com or sales@xyzcompany.com, for example, it would be expected that in some instances a composer may type “Mike” in the initial word sting(s), while in other instances, type “John”. Alternatively, even if only one recipient is using a particular e-mail address, more than one recipient names may be used to refer to that same entity. In the example mentioned, Mike may be the only user of the e-mail mklien@xyzcompany.com, but a composer/sender of an e-mail may refer to them as “Mike”, “Michael”, “M.”, etc. In light of both of the above scenarios, it would be advantageous to have more than one recipient name associated with the same recipient e-mail address. As such, it is preferred that the LA software would be able to associate multiple recipient names to the same recipient e-mail address. In embodiments, once an association has been made between a particular recipient e-mail address and one or more recipient name(s), a warning message will be presented to the sender/creator of the e-mail in instances where a mismatch to the already established associations has been detected. Thus, a sender of an e-mail message can be prevented from mistakenly sending an e-mail message to the wrong e-mail address recipient.

In some embodiments, a user may establish the name associated with the email address in the “setting”/“preferences” of the email system itself.

In order to prevent false positives, the LA software can be configured to not form an association between a designated recipient e-mail address and certain words and/or alphanumeric characters contained in the initial word string(s) that may constitute general language/words and/or punctuation. This is because general language/words and/or punctuation is typically does not constitute a recipient name. Alphanumeric characters in the initial word sting(s) that may constitute general language/words and/or punctuation can include, but are not limited to data strings such as “Hi”, “To”, “Dear”, “Mr.”, “Mrs.”, “Attn”, “Attention”, “Air”, and other such similar words/phrases/data strings. Additionally, there will likely be instances where an e-mail does not contain the recipient's name in the initial word string(s), but instead the initial word string(s) in the body of the e-mail is/are the actual message of the e-mail. Here, the initial word string(s) will be comprised of normal “day-to-day” language/words that are used to convey the particular message of the e-mail and will not include any reference to the recipient's name. In such as case, the LA software will preferably not form an association between any data contained in the initial word sting(s) and designated recipient e-mail address. In some embodiments, a warning alert will not be generated/triggered in scenarios where a recipient name is not detected in the initial word sting(s) of the body of the e-mail. Some embodiments may be configured to refrain from alerting if the email is being sent as a reply (i.e. wherein the sender hits a “reply” button prior to composing the email).

The warning alert as discussed above can be any message that alerts the sender/composer of the e-mail of which recipient or recipient e-mail address is going to receive the e-mail message after it is sent. The warning alert is preferably visual, but can also be audible, or a combination of the two; and may be set by the user, according to various embodiments. The warning alert can be presented to the sender/creator of the e-mail at any time after a recipient e-mail address has been designated for the e-mail being composed and a recipient name is present in the initial word string(s) of the body of the e-mail. Preferably, however, the warning message will be presented and displayed to the sender/composer of the e-mail after the sender/composer clicks on the “Send” function in the e-mail creation software which works to send the created e-mail to the designated e-mail address in the “to:”, “cc:”, or “bcc:” portion of the e-mail creation software. While there may be multiple ways of presenting and displaying the warning alert to the sender/creator of the e-mail message, one notable embodiment would present a pop up window/box that presents the warning message. For example, as illustrated in FIG. 6, upon triggering of the warning alert, a pop-up window/box 22 with the message, “You are about to send this e-mail to samuel@abcco.com” 23 may appear with two click options at the bottom (one being “Send” 24 while the other being “Cancel”25). If the sender/composer clicks “Send”, then the e-mail message will be sent to the designated e-mail address. On the other hand, if the “Cancel” button is clicked, the e-mail message will not be sent and the sender/composer will be taken back to the e-mail in order to edit the recipient e-mail address. In the FIG. 2 example, since the recipient name “Sam” (not shown) had been previously associated with the recipient e-mail address “samuel@abcco.com” 25 the detection of the recipient name “Mike” 12 (instead of the name “Sam”) in the initial word string(s) 17 of the body portion 14 of the e-mail 11 would trigger the warning alert 22. In another example of an alert message, a pop-up window/box may appear containing the message, “There is a possible mismatch between the intended recipient and designated recipient e-mail address”. This message may similarly contain a “Send” and “Cancel” button click options. Various other forms of the warning alert message can likewise be created to alert that there is a possible mismatch between the intended recipient and designated recipient e-mail address.

While a creator of an e-mail generally designates only one recipient e-mail address to send the e-mail message to, there may be instances where the creator designates one or more recipient e-mail address(s) in the “cc:” and/or “bcc” address field(s) that is in addition to the recipient e-mail address designated in the “to:” field. In such a case, the software (e.g. LA software) may likewise trigger a warning alert if the designated e-mail address(s) in the “cc:” and/or “bcc:” field(s) indicate an association mismatch between the recipient name (in the initial word string(s)) and the e-mail address(s) in the “cc:” and/or “bcc:” field(s). Similarly, the same would happen if there are multiple distinct recipient e-mail addresses in the “to” field and there is an association mismatch between the recipient name (in the initial word string(s)) and any one of the additional designated recipient e-mail addresses in the “to:” field.

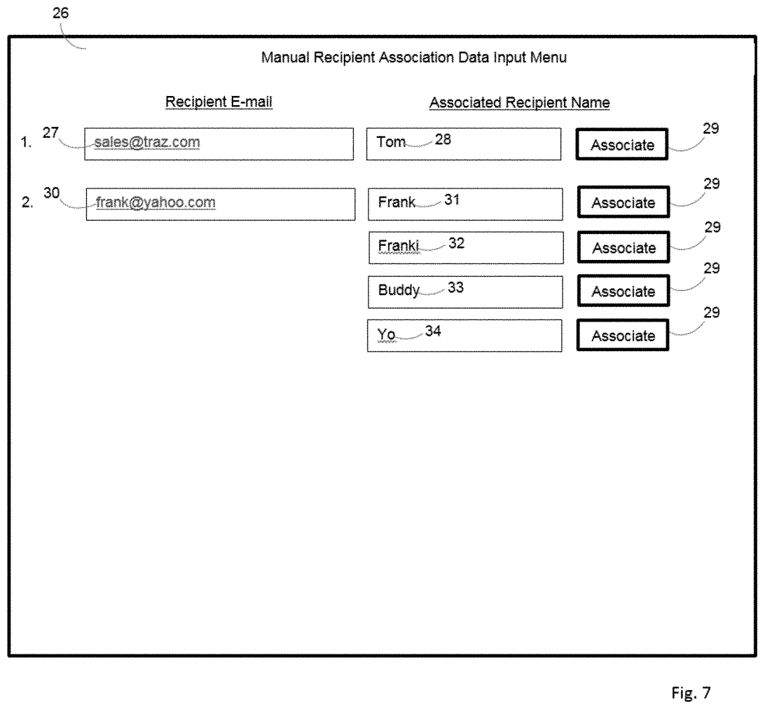

As previously mentioned, associating a recipient name (contained in the initial word string(s)) to a particular recipient e-mail address can also be done by manual association (MA). Manual Association pertains to a process where the user of a particular e-mail address manually creates associations between recipient e-mail addresses and recipient names, such as in a “preferences” and/or “settings” of the email account system. For example, a user of a particular e-mail address may access a data portion of their e-mail account platform that allows them to correlate recipient e-mail addresses with their appropriate e-mail recipients. As illustrated in FIG. 7 a Manual Recipient Association Data Input menu 26 of the user's e-mail account platform allows them to select or enter a recipient e-mail address in the left side box, and manually type one or more recipient name(s) in the data box(s) to the right. In this embodiment, the recipient e-mail “sales@traz.com” 27 was selected from the e-mail user's e-mail address book and inserted in the no. 1 left side data box. To the right of that box, the user entered the recipient name of “Tom” 28 and clicked on the “Associate” 29 button. This process would result in the manual creation of an association between the recipient e-mail sales@traz.com 27 and the recipient name “Tom” 29. Of course, the e-mail entered in the left data box (sales@traz.com 27 in this example) could have also been manually typed instead of selected from the e-mail account user's address book. Similarly, as shown in the no. 2 left side data box, a recipient e-mail address can be associated with more than one recipient names. As likewise illustrated in FIG. 2, the recipient e-mail address, frank@yahoo.com 30 was associated with the names, “Frank” 31, “Franki” 32, “Buddy” 33, and “Yo” 34, noting that all of these names have been entered into the corresponding data boxes to the right. It is noteworthy that Manual Association allows for the user of a particular e-mail account to quickly establish associations in an instant and verified manner. Additionally, it allows the e-mail user to associate a recipient name that is comprised of any alphanumeric formation, including normal day-to-day language that may be ignored by the LA software.

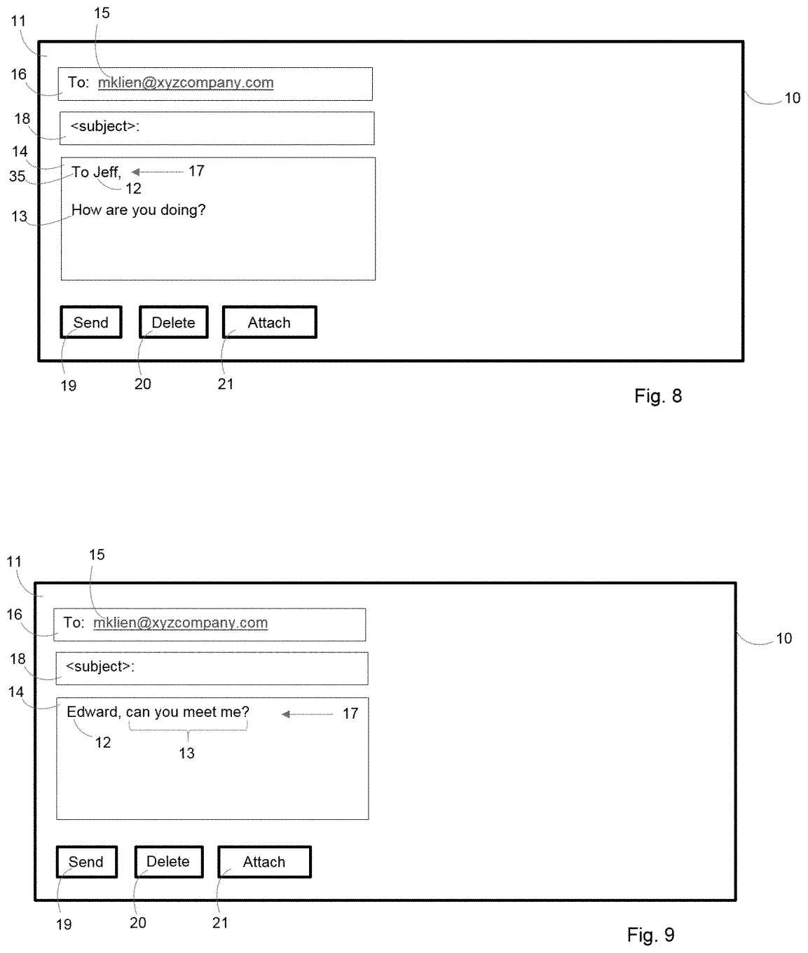

It is notable that the initial word string(s) is typically comprised of the first few alphanumeric characters in the first line of the e-mail body. These first few alphanumeric characters can comprise of one or more words or characters and typically appear in the first 1-4 words of the body of the e-mail. This first line of an e-mail typically contains the salutation to the e-mail recipient, which in most cases indicates the recipient's name. As shown in FIG. 8 the initial word string(s) 17 contains the salutation, “To Jeff” 35. In this instance, “Jeff” 12 would constitute the recipient's name and would be detected by the LA software as such. As previously noted, the word “to” (which proceeds “Jeff”) would generally not be designated by the LA software as the recipient's name (or part of it) as it qualifies as common language unlike the word “Jeff” which does not. Similarly if the initial word string(s) 17 in the example was “Mr. Adkins” instead of “To Jeff”, the word “Adkins” would be designated by the LA software as the recipient's name and “Mr.” would be excluded. Of course, the initial word string(s) 17 may just comprise of the recipient's name such as “Jeff” 12 without having another data word string (e.g. “To”) before or after it. While the first line of an e-mail body typically only contains the salutation (with the second and subsequent lines containing the message), it may likewise contain the message being conveyed in the e-mail. In this embodiment, the recipient's name (e.g. “Edward” 12 (which is contained in the initial word string(s)) 17 and the message portion 13 of the e-mail 11 would both be contained in the first line of the e-mail body 14. This is shown in FIG. 9. Despite this, the LA software would still be able to determine the recipient name due to the fact that it is contained in the initial word string(s) 12 which are typically within the first 3 or so words of the e-mail body 14. Moreover, various guideline rules (as previously mentioned) such as ignoring normal day-to-day language would allow the LA software to determine that none of the data forming the message portion 13, (e.g. “can you meet me?”) constitutes the recipient's name.

Other factors which may allow the software to detect a recipient name may include recognition of common names (e.g. Mike, Bob, Joe), recognition of non-dictionary words, regardless of whether they are common names (e.g. Merp, Lief, etc.), use of capitalization, etc., including a combination of any of the above-mentioned factors, according to various embodiments.

It is noteworthy that a recipient's name can be a first name, a last name, a first and last name, or some unique data string that is outside the scope of common-day-to-day language. In order to determine the recipient name when such is present in the body of the e-mail being created, the LA software may apply a structured rule set that may include, but is not limited to: 1. searching within the initial word string(s) in the first line of the body of the e-mail message, 2. excluding common/normal day-to-day language, and 3. referencing a directory of male and female first names, and last names. Of course, the optimal way of enabling the LA software to do this may employ other programming methods, processes, and tasks that are best known to those skilled in the art and need not be mentioned herein.

It is also noteworthy that a recipient's name may be associated with a designated recipient e-mail address irrespective of the alphanumeric content and/or description of the recipient e-mail address. For example, the recipient name “Charlie” can be associated with any of the following e-mails: sales@foxco.com, charlie@foxco.com, thomas@foxco.com, sport45@google.com, etc. Moreover, any recipient e-mail address, irrespective of whether it is utilized for business, private individual use, etc., may be associated with a recipient name of any alphanumeric composition.

A composer of an e-mail can utilize multiple devices (e.g. “creation devices”) to create an e-mail. Such devices include, but are not limited to mobile devices (such as a tablet or smart phone, etc.), and personal computers (such as a laptop or desktop) and are typically comprised of one or more of the following: a CPU (central processing unit), a data storage device, a display screen, and a keyboard (which may be software based or actual hardware). The creation devices used to compose an e-mail are typically connected to the Internet (i.e. being online) during the creation of an e-mail, but can likewise be offline (not connected to the Internet) during the e-mail creation process. These creation devices typically have access to and utilize an e-mail platform software which allows for an e-mail to be created and sent to a recipient.

On a different note, e-mail platforms are typically comprised of software that allows a user to send, receive, compose, edit, and store e-mail messages through a particular e-mail account. E-mail platform software can be installed to run on a remote host server, a local network server, as well as a user's creation device (e.g. personal computer, smartphone, tablet, etc.). Depending on where the e-mail platform software is located/installed, individuals can access it either online (via the Internet) or offline in order to access their e-mail account for creating, reviewing, processing, and sending e-mails. The software that enables the functionality for verifying that an e-mail is being sent to the intended recipient (as described in this invention) may comprise of program code and/or one or more program module(s) implemented with the e-mail platforms of any e-mail service provider and/or hosting service (whether remotely based or local). This includes, but is not limited to: Microsoft Outlook®, Google Gmail®, Yahoo Mail®, GoDaddy E-mail ®, 3^{rd} party e-mail service providers, private e-mail service providers, in-house server based e-mail platforms, etc. Additionally, the method and system described is equally applicable to both web access online e-mail platforms as well as local computer access e-mail platform which utilizes e-mail software (such as Microsoft Outlook®) installed on the e-mail creator's local computer. To this affect, the method and system for verifying that an e-mail is sent to the intended recipient prior to the e-mail actually being sent by the sender can function in both an online, cloud, and off-line environment. In other words, irrespective whether an e-mail is composed online (i.e. while being connected to the Internet), or offline (when not connected to the Internet), the functionalities described in this method and system can be implemented with the particular e-mail platform being utilized. It should also be noted that in addition to the Internet environment, this invention is similarly applicable to Intranet environments.

An exemplary apparatus configured to carry out the disclosed may comprise one or more processors, system memory, and one or more non-transitory memory units, all of which may be directly or indirectly coupled to and/or in communication with each other. In embodiments, data may be input to and/or output from the apparatus through a user interface which may be in communication with at least one user interactive device. The user interactive device may comprise, for example, a keyboard, and/or a visualization screen, which may include a touch interactive screen. In embodiments, a user may interact with apparatus via the at least one user interactive device and through the user interface.

The methods, systems, process flows and logic of disclosed subject matter associated with a computer readable medium may be described in the general context of computer-executable instructions, such as, for example, program modules, which may be executed by a computer. Generally, program modules may include routines, programs, objects, components, data structures, etc. that perform particular tasks or implement particular abstract data types. Such modules are typically stored on a data storage media of the host computer that is remotely or locally situated. The disclosed subject matter may also be practiced in distributed computing environments wherein tasks are performed by remote processing devices that are linked through a communications network. In a distributed computing environment, program modules may be located in local and/or remote computer storage media including memory storage devices.

The detailed description set forth herein in connection with the appended drawings may be intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

This detailed description of illustrative embodiments includes specific details for providing a thorough understanding of the presently disclosed subject matter. However, it will be apparent to those skilled in the art that the presently disclosed subject matter may be practiced without these specific details. In some instances, well-known structures and devices are shown in block diagram form in order to avoid obscuring the concepts of the presently disclosed method and system.

The foregoing description of embodiments may be provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims may be not intended to be limited to the embodiments shown herein, but may be to be accorded the widest scope consistent with the principles and novel features disclosed herein. It may be contemplated that additional embodiments are within the spirit and true scope of the disclosed subject matter.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more”. Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for”. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

It will be appreciated that variations of the above-disclosed and other features and functions, or alternatives thereof, may be desirably combined into many other different systems or applications. Also that various, presently unforeseen or unanticipated, alternatives, modifications, variations or improvements therein may be subsequently made by those skilled in the art which are also intended to be encompassed by the following claims.

The detailed description set forth herein in connection with the appended drawings may be intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

This detailed description of illustrative embodiments includes specific details for providing a thorough understanding of the presently disclosed subject matter. However, it will be apparent to those skilled in the art that the presently disclosed subject matter may be practiced without these specific details. In some instances, well-known structures and devices are shown in block diagram form in order to avoid obscuring the concepts of the presently disclosed apparatus.

The foregoing description of embodiments may be provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims may be not intended to be limited to the embodiments shown herein, but may be to be accorded the widest scope consistent with the principles and novel features disclosed herein. It may be contemplated that additional embodiments are within the spirit and true scope of the disclosed subject matter.

1. An electronic communication method for detecting error in information inputted in a recipient field of an electronic communication, said method comprising:
detecting at least one recipient name from a body of an electronic communication;
comparing the at least one recipient name with a destination indication inputted in the recipient field of the electronic communication;
determining whether there is a match, a mismatch, or a potential mismatch between: a) said at least one recipient name, and b) said destination indication; and
upon determination of a mismatch or potential mismatch, issuing an alert that the information inputted in the recipient field may be incorrect, wherein the electronic communication method is configured to deter transmission of the electronic communication to an unintended recipient by issuing said alert,
wherein the electronic communication method is automated and reduces the risk of transmitting the electronic communication to the unintended recipient by providing a verification of the information entered in the recipient field to reduce human error,
wherein the destination indication is at least one of an electronic e-mail address, a phone number, or other electronic destination identifier,
wherein the electronic communication method is implemented via software and/or hardware resident on an electronic device.

2. The electronic communication method of claim 1, further comprising detecting at least one destination name associated with the destination indication wherein the at least one destination name comprises a text string associated with a name.

3. The electronic communication method of claim 1, wherein said alert is issued upon an attempt to transmit said electronic communication.

4. The electronic communication method of claim 1, wherein if a mismatch and/or potential mismatch is determined, issuing an alert as to a potential error concerning the destination indication inputted in the recipient field, prior to transmission of said electronic communication.

5. The electronic communication method of claim 1, further comprising learning an association between the at least one recipient name and the recipient destination indication.

6. The electronic communication method of claim 1, comprising comparing the at least one recipient name with the at least one destination indication by using an established association relating to the destination indication.

7. The electronic communication method of claim 1, wherein detecting at least one recipient name from the body of the communication comprises searching for at least one of:
an initial word string of the body of the communication;
a recognized common name;
a name from a preprogrammed list of names
an unrecognizable word;
a word string comprising a capitalized first letter;
a word string following a common salutation;
a word string in the first line of the body message;
a name associated with the destination indication;
or a combination thereof.

8. The electronic communication method of claim 1, wherein the destination name is at least part of a text string in the destination indication, or an identification name associated with the destination indication.

9. The electronic communication method of claim 1, wherein the electronic communication comprises an email, and wherein the recipient destination indication is an email address.

10. The electronic communication method of claim 1, wherein the electronic communication is a text message, and the destination indication is a phone number.

11. An electronic communication system for detecting error in information inputted in a recipient field of an electronic communication, and reducing the risk of sending the electronic communication to an unintended recipient, the system comprising:
software configured to perform an automated determination of whether a recipient name entered into a body of an electronic communication is a match, a mismatch or a potential mismatch, with a) a destination indication inputted in the recipient field of the electronic communication or b) a name associated with the destination indication inputted in the recipient field,
wherein said system is further configured to deter transmission of the electronic communication to an unintended recipient by issuing an alert of a potential error in the destination indication upon determination of a mismatch or potential mismatch,
wherein the automated determination reduces the risk of transmitting the electronic communication to an unintended recipient, by providing a verification of the information entered in the recipient field to reduce human error in entering the wrong destination indication,
wherein the destination indication is at least one of an electronic e-mail address, a phone number, or other electronic destination identifier.

12. The electronic communication system of claim 11, wherein said software is configured to detect said recipient name from said electronic communication.

13. The electronic communication system of claim 11, wherein said automated determination comprises using a pre-established association between the entered destination indication and a recipient name previously associated with the entered destination indication, to determine whether the previously associated recipient name matches said recipient name entered in the body of the electronic communication.

14. The electronic communication system of claim 13, wherein said pre-established association is based on a repeated occurrence of a specific recipient name being used with a specific destination indication, a confirmation that a destination indication and a recipient name are accurately associated, or a manually established association, or combinations thereof.

15. The electronic communication system of claim 11, wherein the at least one recipient name comprises at least one text string potentially associated with a name in the body of the communication, or wherein the at least one destination name is at least part of a text string in the destination indication or an identification name associated with the destination indication.

16. The electronic communication system of claim 11, wherein if a mismatch or potential mismatch is determined, prompting a composer of the electronic communication to confirm the destination indication prior to transmission of said electronic communication.

17. The electronic communication system of claim 11, wherein the electronic communication comprises an email, and wherein the destination indication is an email address.

18. The electronic communication system of claim 11, wherein the electronic communication is a text message, and the destination indication is a phone number.

19. An email method to reduce a risk of transmitting an email to an unintended recipient and for detecting an incorrect email address inputted in a recipient field of the email, the email method comprising:
detecting a recipient name from a body of an e-mail message;
detecting an e-mail address from the recipient field of the e-mail message;
comparing the recipient name with the email address or a name associated with the email address;
determining whether there is a match, a mismatch, or a potential mismatch between: a) the recipient name, and b) the email address or the name associated with the email address; and
issuing an alert that the email address inputted in the recipient field may be incorrect, if a mismatch or potential mismatch is determined, wherein the method is configured to deter transmission of the email to an unintended recipient by issuing said alert,
wherein the method reduces the risk of transmitting the email to the unintended recipient by providing a verification of the information entered in the recipient field,
wherein the method is automated and implemented via software resident on at least one computer device, and wherein the method provides a verification of the email address entered in the recipient field to reduce human error.

20. The email method of claim 19, wherein said determining whether there is a match, a mismatch, or a potential mismatch comprises at least one of:
using a pre-established association between the email address and a recipient name previously associated with the email address, or
determining whether a text string in the detected recipient name matches a text string in the email address or the name associated with the email address.
